(19) United States
(12) Patent Application Publication
(10) Pub. No.: US 2012/0192490 A1
(43) Pub. Date: Aug. 2, 2012

(54) INTENSIVE CARE UNIT DOOR CONTROL SYSTEM

(76) Inventor: MICHAEL MCCASLIN, EASTON, PA (US)

(21) Appl. No.: 13/016,060

(22) Filed: Jan. 28, 2011

(51) Int. Cl. E05F 15/20; E06B 3/46; E05B 65/08; E05F 15/06

(52) U.S. Cl. 49/31; 49/358; 49/506

(57) ABSTRACT

The present invention relates to doors for intensive care units and more particularly to an intensive care unit door control system. In particular, the invention relates to a door management system for an intensive care unit comprising at least one control unit configured to receive signals from at least one external device and to control the opening and closing of the automatic intensive care unit doors based on the received signals.

### TECHNICAL FIELD

The present invention relates to doors for intensive care units and more particularly to an intensive care unit door control system. The invention also relates to a method for operating the doors in an intensive care unit.

### BACKGROUND

An intensive care unit is a hospital unit staffed and equipped to provide intensive care. An increase of requirements on doors used in intensive care units has recently been seen. One requirement is that a intensive care unit door is trackless, that is, the door does not have any threshold or similar arrangement across the door opening, so as to minimize collection of bacteria and various types of debris, and such that patients and intensive care unit equipment can be easily moved through the door opening. Another requirement is that the door should have a UL air leakage rated seal around its perimeter, in order to create a seal that serves to minimize smoke or germ contamination inside the room by reducing air leakage and infiltration.

Furthermore, the door should have a positive latch, that is, the door should be possible to secure to the door jamb or opposing door, so that the door cannot open by itself after the door has been closed. A positive latch is also required to have and a handle that protrudes from the door face.

However, these strict requirements may cause problems to the staff in the hospitals in several situation, when a fast opening of the door is required e.g. due to an emergency message such as a “life alert” or a fire alarm, when valuable life saving seconds are lost when sliding the door out of the way.

Another problem related do doors in intensive care units, may be that visitors, janitorial worker, interns, nurses and doctors all are touching the same lever handle to open the door before visiting the patient. Hence, infectious disease can quickly be spread from room to room.

It may also be desirable to allow or disallow unwanted visitors by keeping the door to an intensive care unit closed and locked, when only approved personnel should be allowed access to the intensive care unit.

Therefore, finding a way of controlling the doors in an intensive care unit, which mitigates or alleviates the above-mentioned drawbacks, would be most welcome.

### SUMMARY OF THE INVENTION

With the above description in mind, then, one aspect of the present invention is to provide a way of controlling the doors in an intensive care unit, which seeks to mitigate, alleviate, or eliminate one or more of the above- identified deficiencies in the art and disadvantages singly or in any combination.

According to one aspect of the invention, it provides for an intensive care unit door control system for operating the door in an intensive care unit based on signals received from external units. Embodiments of the invention also relate to a method for controlling the doors in such a system. For example, in one embodiment, the invention relates to a door management system for an intensive care unit comprising at least two automatic intensive care unit doors, at least one control unit, said control unit being configured to receive signals from at least one external device; wherein the control unit is configured to control the opening and closing of the automatic intensive care unit doors based on the received signals.

In another embodiment, the door management system comprises a control terminal for inputting information into the system.

In another embodiment, the door management system comprises a plurality of control units, each control unit being adapted to control one intensive care unit door.

In another embodiment, the door management system comprises a central control unit adapted to control all doors.

In another embodiment, the at least one external unit is a sensor, a switch, a reader or a fire detection system.

In another embodiment, a door management system is provided wherein at least one signal is received from a medical device that alerts medical personnel that a patient requires care.

In another embodiment, the control unit is further adapted to receive at least one internal signal.

In another embodiment, the at least one internal signal is a signal from a senor, a switch or a reader.

In another embodiment, the intensive care unit door has a positive latch function.

According to aspects of the invention, a method is also provided for operating the doors in an intensive care unit door, comprising at least two automatic intensive care unit doors and at least one control unit, comprising the steps of receiving in said at least one control unit at least one signal from a first external device; and controlling by said at least one control unit the opening and closing of the automatic intensive care unit doors based on the received signals.

In another embodiment, the method comprises receiving information from a control terminal.

In another embodiment, the method comprises providing a plurality of control units which control one intensive care unit door each.

In another embodiment, the method comprises providing a central control unit which controls all doors in the intensive care unit.

In another embodiment, the method comprises providing at least one external unit which is a sensor, a switch, or a reader.

In another embodiment, the method comprises providing at least one received signal which is a signal from a fire detection system.

In another embodiment, the method comprises providing at least one received signal which is a signal from a medical device that alerts medical personnel that a patient requires care.

In another embodiment, the method comprises receiving at least one internal signal.

In another embodiment, the method comprises providing at least one internal signal which is a signal from a sensor, a switch or a reader.

In another embodiment, the intensive care unit door has a positive latch function.

By providing a system wherein the doors may be touchlessly controlled, via sensors, switches, readers or remote controllers, the spread of infectious diseases in the hospital may decrease.

By controlling the door opening by signals from medical equipment alerting medical personnel about a life threatening condition, the doors may be automatically slid out of the way and valuable seconds may be saved.

Furthermore, the possibility to centrally control the doors of a ward individually or simultaneously may save time for the medical personnel in many situations. By controlling the doors using remote controls, a patient may open and unlock the door to his room without assistance.

### BRIEF DESCRIPTION OF THE DRAWINGS

Further objects and features, of the present invention will appear from the following detailed description of embodiments of the invention, wherein the embodiments will be described in more detail with reference to the accompanying drawings, in which:

FIG. 1a shows a manual intensive care unit door package according to prior art and FIG. 1b shows a manual latch.

FIG. 2 shows an automatic intensive care unit door package.

FIGS. 3a and 3b shows an automated strike.

FIG. 3c shows the manual latch disclosed in FIG. 1b in cooperation with the automated strike.

FIG. 4 illustrates in a flow chart a method for opening an automatic intensive care unit door.

FIG. 5 illustrates in a flow chart a method for closing an automatic intensive care unit door.

FIG. 6 illustrates a centralized intensive care unit door control system.

FIG. 7 illustrates a distributed intensive care unit door control system.

It should be added, that the following description of the embodiments is for illustration purposes only and should not be interpreted as limiting the invention exclusively to these embodiments/aspects.

### DETAILED DESCRIPTION

Embodiments of the present invention relate to an automatic intensive care unit door and to an intensive care unit door control system. The invention also relates to a method for operating an automatic intensive care unit door.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

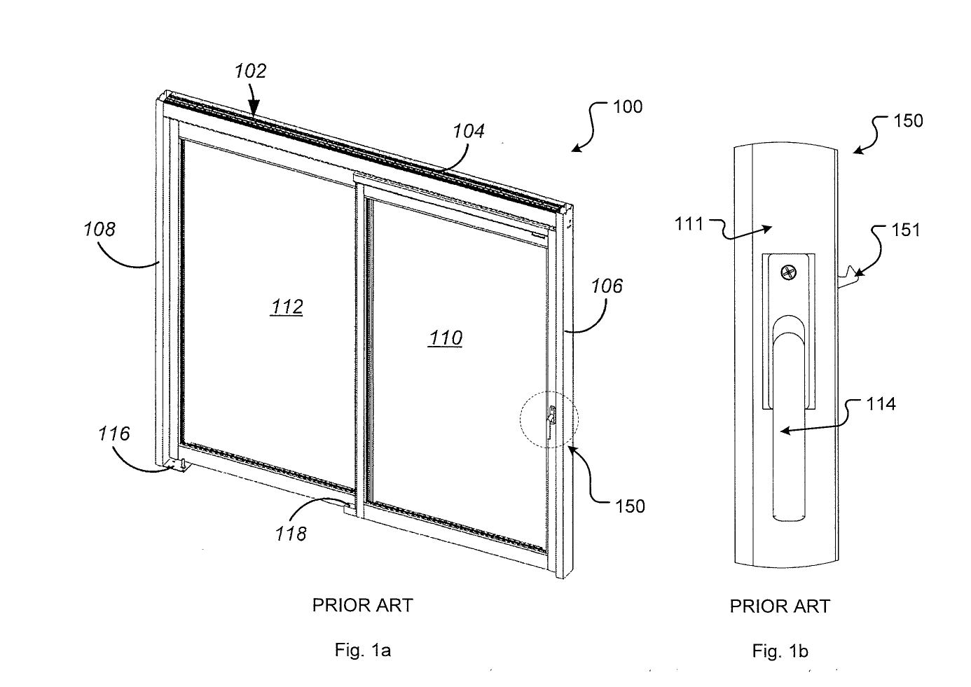

FIG. 1a shows a manual intensive care unit door package 100 according to prior art.

An intensive care unit referred to in this application may e.g. be an intensive care unit (ICU), a critical care unit (CCU) or an intensive therapy unit (ITU). In particular, an intensive care unit refers to a unit in a hospital containing the equipment, medical and nursing staff, and monitoring devices necessary to provide intensive care. However, the ‘intensive care unit door control system’ could also be used for related units, where the requirements on patient monitoring and cleanliness are similar e.g. infectious disease isolation rooms.

An intensive care unit may comprise one or several wards. Each ward may comprise one or several rooms. Each room typically has at least one intensive care unit door package.

As can be seen in FIG. 1, the door package 100 includes a frame 102 that has a top portion 104, a right jamb 106 and a left jamb 108. The frame 102 can be made of any conventional material that is used for manufacturing door frames, as is well known to those of ordinary skill in the art.

Inside the frame 102 is a door with two door panels; a right door panel 110 and a left door panel 112. This type of door is often referred to as a two-panel single slider package. It should be noted that while FIG. 1 shows two door panels, in some embodiments the door can be a so-called telescopic door, that is, a door containing three (or more) door panels. In fact, for some applications a three-panel telescopic door may actually be more desirable than a two-panel slider, as the three-panel telescopic door offers a larger clear door opening (CDO) compared to a two-panel slider for a door package of the same size. In the illustrated embodiment, the right door panel 110 can slide behind the left door panel 112 along tracks that are located in the top portion 104 of the frame 102. Of course, as the skilled person realizes, depending on different embodiments, the door package 100 can also be configured such that the left door panel 112 slides behind the right door panel 110. It should further be noted that there are no tracks on the floor in which the right door panel 110 can slide.

That is, the door package (100) is a trackless door package 100. However, the invention may as well be implemented using tracks or wheels or any combination thereof.

Attached to the right door panel 110 is a latch 150 that can positively latch into the right jamb 106. The latch handle 114 protrudes from either side of the right door panel 110 and can be gripped by a person and rotated slightly to unlatch the right door panel 110 from the left jamb 106. While holding the handle 114, the person can slide the right door panel 110 behind the left panel 112 to achieve a maximum clear door opening (CDO) of the door in relation to its package size.

FIG. 1b shows the latch 150 in more detail. The latch 150 comprises an L-shaped latch hook 151 and a handle 114. A lever, not shown, transfers movement from the handle 114 to the latch hook 151. A spring is adapted to apply a spring force on latch hook 151 in a vertical direction.

The latch hook 151 is adapted to engage with a strike plate, when the door 110 is closed. Thereby a positive latch function is achieved.

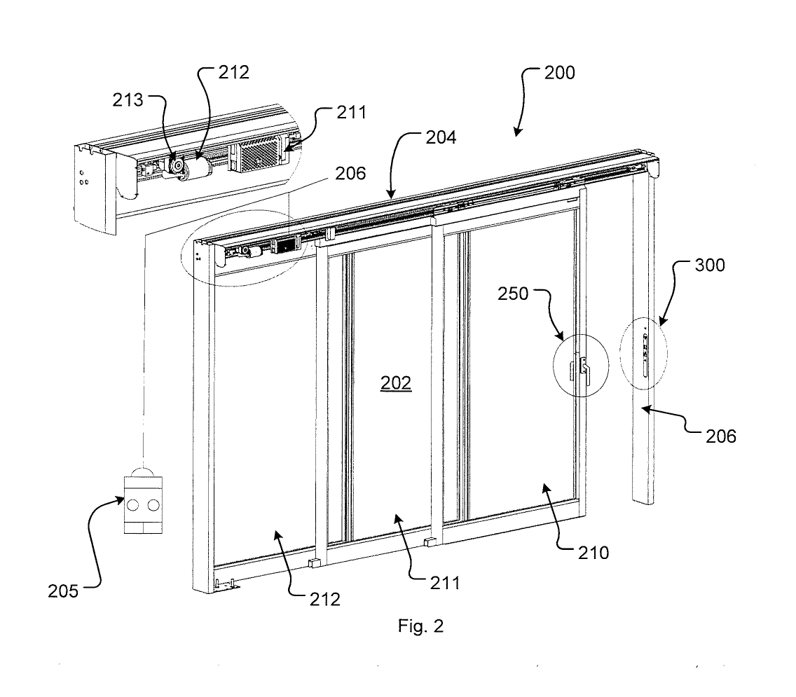

FIG. 2 shows an overview of an automatic intensive care unit door package 200. An automatic door is a self-opening door, i.e. a door, which may be opened without using manual force. The opening is in most cases electric, i.e. performed by an electric motor.

The door package 200 comprises a door 202 comprising three door panels, a left door panel 212, a middle door panel 211 and a right door panel 210. Attached to the right door panel 210 is a latch 150 that can positively latch into the right jamb 206. The automatic intensive care unit door package 200 is constructed in the same manner as the manual intensive care unit door package described in relation to FIG. 1 except for the difference that an automation kit is installed. An automation kit may be installed in the factory. An automation kit may also be retrofitted to an already installed door.

The automation kit comprises e.g. a control unit 211, an automated strike 300 and drive means 220.

The control unit 211 is connected to an internal switch 205 and to an external signal 206. The control unit 211 controls the operation of the automatic intensive care unit door package 200, based on the received signals.

The drive means 220 is located in the top portion 204 of the frame and comprises a tooth belt and a drive wheel, not visible, a gear box 213 and an electrical motor 212. The drive means 220 are adapted to open and close the door 202.

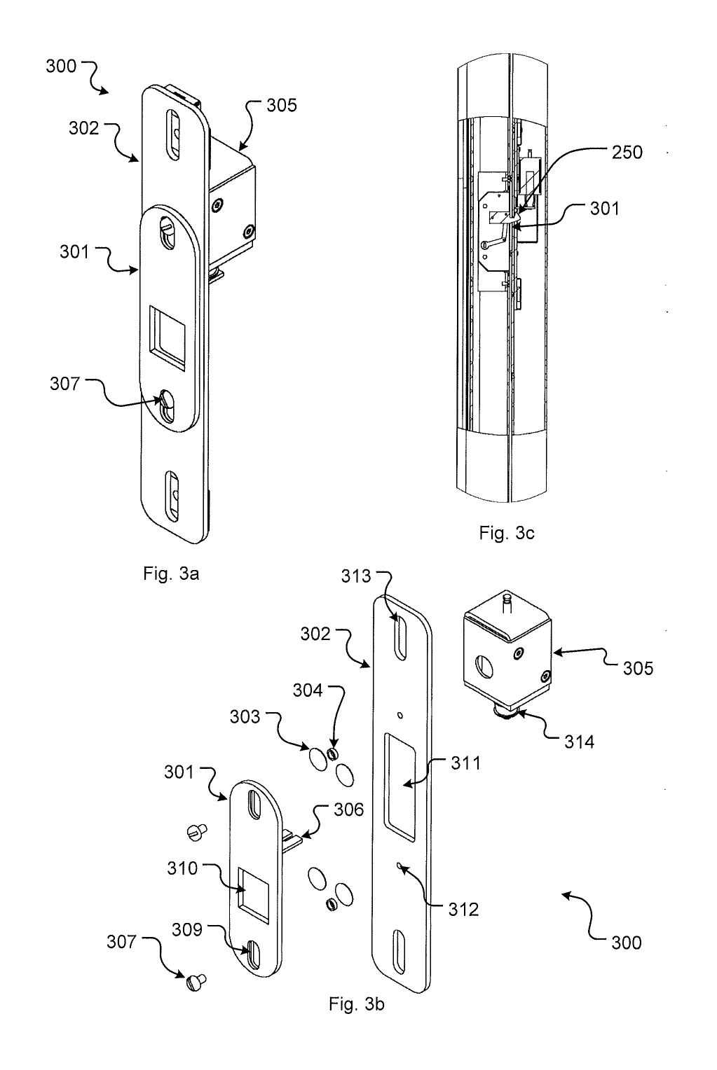

Due to the requirement on the intensive care unit door to have a positive latch function, an automatic intensive care unit door requires a latch, which may be operated both manually and automatically. The automated strike 300 operates together with the manual latch 150, which is the same latch 150 used in the manual door, shown in FIG. 1b. The automated strike 300 enables automatic releasing of the latch 150. The automated strike 300 is described in detail in FIGS. 3a to 3b.

FIGS. 3a and 3b disclose a strike, which allows a sliding door to function both in a manual mode and in an automatic mode. Thereby, a positive latch, which may be automatically operated, is provided. The automated strike 300 may cooperate with the latch 150 described in FIG. 1b.

The automated strike 300 comprises a strike plate 301, a back plate 302, plastic discs 303, a strike spacer 304, a solenoid assembly 305, a strike connector 306 and mounting screws 307.

The strike plate 301 is an oblong flat piece made of e.g. metal. The strike plate is shown from the back in FIG. 3c. The strike plate has a central aperture 310. The strike plate has two slots 309 extending along the oblong strike plate 301. The slots are adapted to mount the strike plate 301 to a back plate 302. The slots 309 are positioned one at each end portion of the strike plate 301, with the central aperture 310 in between. The slots 309 in the strike plate 301, are arranged to allow the automatic movement up/down of the strike plate 301 in relation to the back plate 302. These slots 309 may e.g. be 6.4×17.4 mm with a 8.4×17.4×1.5 mm counter bore to accommodate a strike spacer 304 and screws 307 e.g. M4 pan head machine screws, that fastens the strike plate 301 to the back plate 302.

The back plate 302 is also an oblong flat piece of e.g. metal. The back plate 302 has a central aperture 311, two holes 312 and two slots 313. The slots 313 are adapted to mount the strike plate 301 to the door jamb 106. The slots extend along the back plate 302 to allow for adjustment of the entire automated strike 300 to correspond with the vertical position of the door 202. The holes 312 are adapted to receive the screws 307.

The strike connector 306 is a piece of metal extending perpendicularly from the strike plate 301 towards the back plate 302 and through the central aperture 311 of the back plate 302. The strike connector is adapted to be connected to a core 314, which cooperates with a solenoid, not shown in order to move the strike plate 301. The strike connector 306 is attached to the strike plate 301 by welding. It may also be bonded or attached with screws; in this embodiment, welding is preferred to achieve the design goal of eliminating exposed fasteners.

The strike plate 301 is slidably attached to the back plate 302. Hence, when mounted, the strike plate 301 may be slided in a vertical direction in order to disengage the latch hook 151.

Between the strike plate 301 and the back plate 302, there are strike spacers 304 and plastic discs 303 e.g., 4 self-adhesive UHMW discs 12.7 mm diameter×0.012 thickness, to prevent noise and reduce friction, when sliding the strike plate 301. The same result may be accomplished using grease or some type of bearing.

The solenoid assembly 305 comprises a solenoid, not shown, and a core 314 positioned inside the solenoid. The solenoid and core 414 are used to move the strike plate 301 in a vertical direction. The solenoid assembly 305 is attached to the back side of the back plate 302, i.e. inside the door jamb 206. Thereby, the core 314 is positioned right above the strike connector 306, such that it can be connected to the strike connector. The solenoid is activated by a 12 VDC current supplied from an external power source, not shown. When the solenoid is activated, the core 314 moves in a vertical direction, due to the magnetic field created by the solenoid.

FIG. 3c shows the latch 150 in engagement with the strike plate 301. When the latch has cleared the central aperture 310 a spring pulls it upwards and the vertical limb engages with the back side of the strike plate 301. The back side refers to the side facing the door jamb 206.

In the manual mode the latch hook 151 can be disengaged from the strike plate 301 by rotating the latch handle 114 and thereby moving the latch hook 151 downwards, such that the vertical limb of the latch hook 151 can move under the upper edge of the central aperture 310. Thereby the door is unlatched.

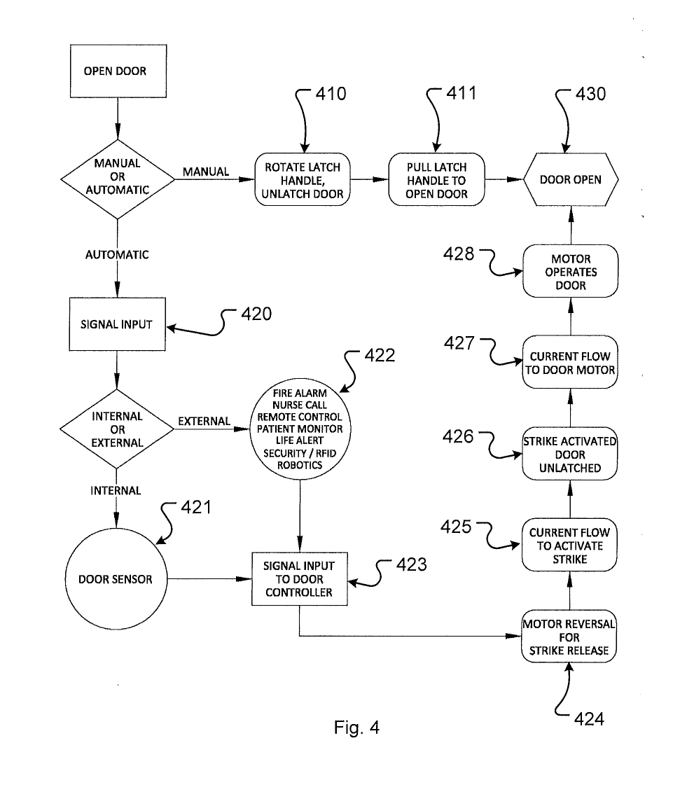

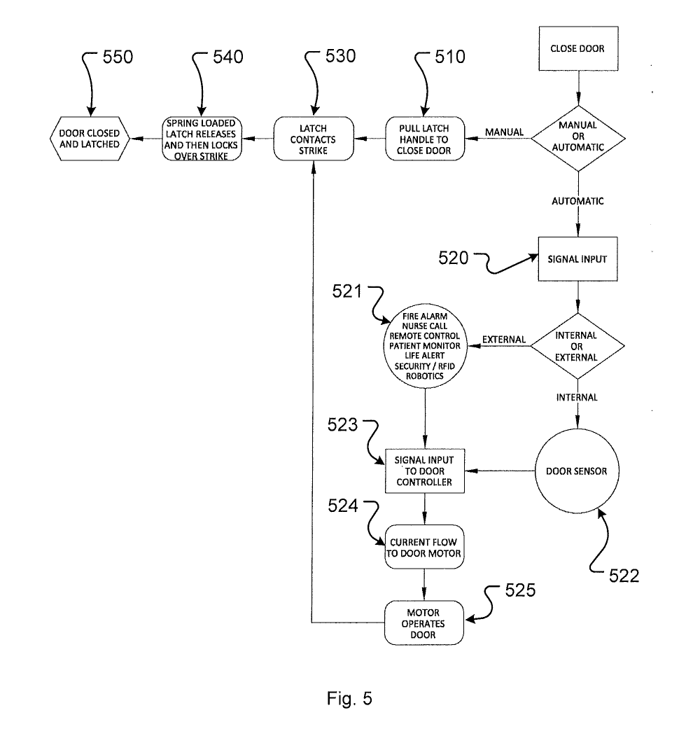

In the automatic mode the automated strike 300 may be released by sliding the strike plate 301 over the latch hook 151. This is possible as the strike plate 301 is slidable in a vertical direction in relation to the back plate 302 and because the strike comprises driving means for driving the strike plate. As the back plate is fixed mounted to the door jamb 106, the strike plate 301 is slidable in relation to the door jamb 106 and to the latch hook 151 as well. The operation of the automatic door package will be further described in relation to FIG. 4 and FIG. 5.

The method for operating the door 202 shown in FIG. 2 is now described in more detail with reference to FIGS. 4 and 5.

FIG. 4 illustrates a method for opening a door 202 in an intensive care unit. The door 202 may be opened manually or automatically.

The manual opening manually is initiated by step 410 wherein a person manually rotates the handle 114 in order to unlatch the door 202. When the latch is released the person moves the right door panel 110 towards its open position by pulling the handle 114, step 411. The manual opening of the door may be assisted by the electric motor 212. When the right door panel 210 and the middle door panel 211 is completely behind the left door panel 212 the door is open 430.

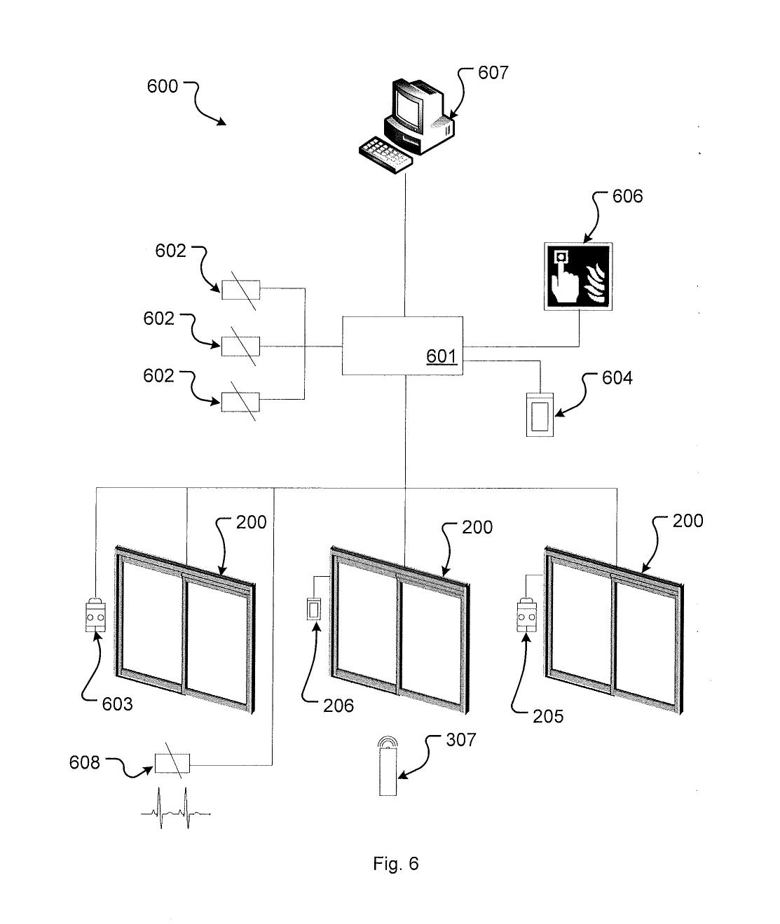

The automatic opening is triggered by a signal input 420. The signal may be internal 421 or external 422. When receiving the signal to close a door the central control unit 601 (described in FIG. 6) sends an input to the control unit 211 of the door or doors 200 concerned, step 423. When the control unit 211 receives a signal to open the door, the motor 212 briefly (milliseconds) runs, in the reverse (closing) direction to remove any pressure on the latch 150, step 424. The control unit 211 activates a current flow through the driving means, i.e. solenoid of the strike 300, step 425. Thereafter, the latch 150 is released and the door 202 is unlatched, step 426. The control unit 211 then activates a current flow to the motor 212, step 427. The motor 212 operates the door 202 and drives the right door panel 210 and middle door panel 211 towards its open position, step 428. When the right door panel 210 and the middle door panel 211 is completely behind the left door panel 212 the door is open 430.

FIG. 5 discloses a method for closing a door in an intensive care unit. The door may be closed manually or automatically.

The manual closing is initiated by step 510 where a person moves the right door panel 210 and middle door panel 211 by pulling the handle 114. The manual closing of the door may be assisted by the electric motor 212. When the door has reached its closed position, the latch hook 151 contacts the strike plate 301, step 530. The spring loaded latch hook 151 then releases and locks over the strike plate 301 step 540. The door is then in a closed and latched position, 550.

The automatic closing is triggered by a signal input as disclosed in step 520. The signal may be internal 521 or external 522. When receiving the signal to close the door the central control unit 501 sends an input to the control unit 211, step 523. The control unit 211 activates a current flow to the motor 212, step 524. The control unit 211 operates the door and drives the door panel to its closed position, step 525. When the door reaches its closed position, the latch hook 151 contacts the strike plate 301, step 530. The spring loaded latch hook 151 then releases and locks over the strike plate 301 step 540. The door is then in a closed and latched position, 550.

In automatic mode, the strike plate 301 may as an alternative stay in its unlatched position during the entire cycle. When the door 202 has reached its closed position, the power to the solenoid is dropped and the strike plate 301 slides over the latch hook 151. Thereby, the vertical limb of the latch hook 151 engages with the back side of the strike plate 301 and the door is closed and latched.

FIG. 6 discloses a centralized system 600 for operating the doors 202 in an intensive care unit. The system comprises three automatic intensive care unit door packages 200, a central control unit 601 and a number of external units. The central control unit 601 receives signals from the external units, whereupon the control unit reacts in order to control the doors of the intensive care unit.

External units are sensors 602, 608, readers 604, push switches 603, a fire detection system 606 or a control terminal 607. The sensor may be an EKG sensor 608 or other medical device that may alert medical personnel that a patient requires care. The sensors 602 may also be proximity sensors or any kind of sensors. The central control 601 unit may also be connected to any kind of switches 603 or readers 604 for controlling the operation of the doors in the system.

The central control unit 601 reacts on pre programmed signals or alarms e.g. the doors may be automatically opened at a specific time, e.g. when it is time for a round or meal service.

The central control unit 601 is connected to each intensive care unit door 202 in the intensive care unit. The central control unit is configured to send signals to the control unit 211 of each door 202 in order to automatically control the opening or closing of the door 202.

The central control unit 601 may control each door 202 in the system 600 individually. The central control unit 601 may also open or close all or several of the doors 202 in the system simultaneously, e.g. for meal service or for a medical round.

The central control 601 unit may also activate and deactivate locking of the doors 202. Thereby only approved personnel will be allowed access through means of e.g. readers 604 such as card readers, proximity readers, key code access readers, security readers, thumb readers. This is especially important for small children.

The system may also allow individual control of each door in the intensive care unit, by an internal unit. An internal unit refers to a unit only controlling one specific door in the system, e.g. a switch 205, reader 206 or by a remote control 207. The internal units e.g. readers 206 may also be configured to lock or unlock each door 202 individually.

The central control unit 601 is connected to a control terminal 607. The terminal is used to input pre-programmed alarms and to program settings for controlling the operation of the intensive care unit door operation system. The control terminal 607 may also be used to input commands to directly control the doors 202.

The switches 603, 206 may be mechanical push switches, electrical mechanical push switches, electrical mechanical “wave” touch less switches.

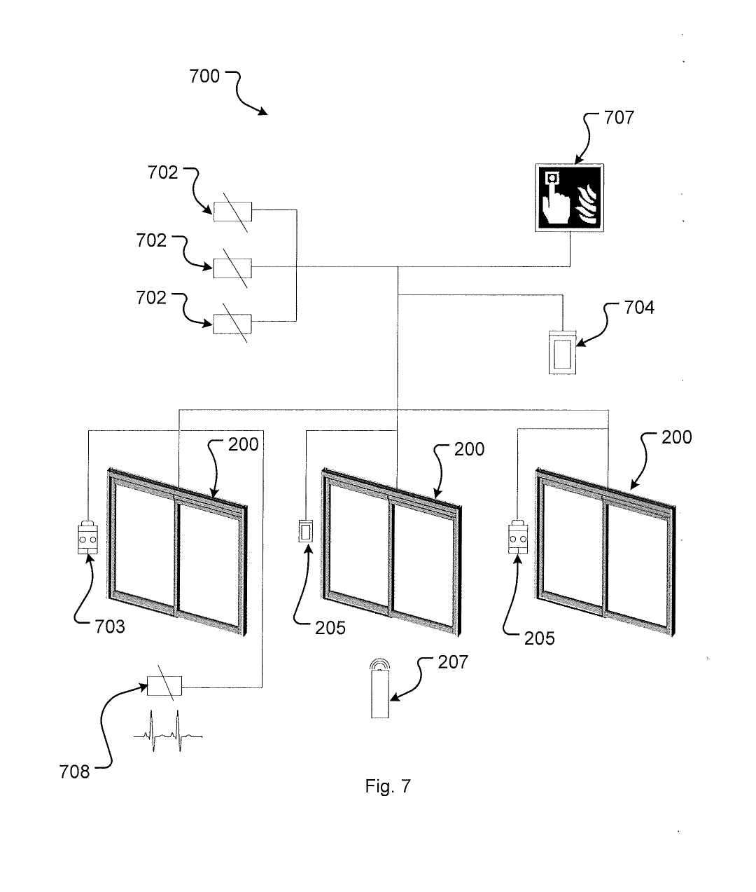

FIG. 7 discloses a distributed system 700 for operating the doors 202 in an intensive care unit. The system comprises three automatic intensive care unit door packages 200, each comprising a control unit 211, and a number of external units. Each control unit 211 receives signals from the external units, whereupon each control unit 211 reacts in order to control respective door 202.

External units are sensors 702, 708, readers 704, push switches 703 or a fire detection system 706. The sensor may be an EKG sensor 608 or other medical device that may alert medical personnel that a patient requires care. The sensors 702 may also be proximity sensors or any kind of sensors.

The control units 211 reacts on pre programmed signals or alarms e.g. the doors may be automatically opened at a specific time, e.g. when it is time for a round or meal service.

The control units 211 may also activate and deactivate locking of the doors 202 based on particular signal inputs. Thereby only approved personnel will be allowed access through means of e.g. readers 704 such as card readers, proximity readers, key code access readers, security readers, thumb readers. This is especially important for small children.

The system may also allow individual control of each door in the intensive care unit, by an internal unit. An internal unit refers to a unit only controlling one specific door in the system, e.g. a switch 205, reader 206 or by a remote control 207. The internal units e.g. readers 206 may also be configured to lock or unlock each door 202 individually.

The switches 703, 206 may be mechanical push switches, electrical mechanical push switches, electrical mechanical “wave” touch less switches.

FIGS. 6 and 7 discloses two examples of how different sensors, switches and scanners may be connected in a system for operating the doors in an intensive care unit. However, it must be assumed that the design of the system may be adapted for the particular needs in a certain situation. Hence, the sensors, switches and scanners may be selected and placed based on the needs in a specific intensive care unit. Furthermore the control of a particular intensive care unit may also be programmed dependent on the routines and needs in the particular system. Furthermore many other different signals may cause the control unit to open or close one or several doors 202 in the systems 600, 700.

According to one aspect of the invention a fire alarm or lock down type emergency signal automatically closes and/or electrically latches one or several doors 202. Smoke packages certified under Underwriters Laboratories standard 1784 (UL1784) that are held open either by the patient, nurse or control system can automatically close and electrically latch to prevent smoke infiltration during a fire alarm, yet still retain the mechanical manual levers for egress.

According to one aspect of the invention a “code” or “life alert” type emergency response automatically opens the door prior to emergency personnel arrival. If the patient is having an emergency and there is a signal sent to the automatic door operator, it can open the door prior to the arrival of the emergency personnel in order to save valuable life saving seconds by sliding the door out of the way.

According to one aspect of the invention a nurse call signal automatically opens the door. Hence, if the patient calls the nurse, the door opens prior to their arrival.

According to one aspect of the invention a remote control signal generated by patient and/or nurse may automatically opens or closes the door. Patients or nurses can have a hand held remote controls, or remote located control to control the opening or closing of the doors.

According to one aspect of the invention a signal indicating a round or meal service may automatically open all doors in a given intensive care unit.

According to one aspect of the invention a touchless sensor may open a door—given that family visitors, janitorial worker, interns, nurses and doctors all are touching the same lever handle to open the door before working with the patient, infectious disease can quickly be spread from room to room. Touchless automation will allow this door to open by just a wave of the hand or close proximity to the door in order not to spread germs and disease to already weaken patients.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

What is claimed is:

1. A door management system for an intensive care unit comprising:
a. at least two automatic intensive care unit doors; and
b. at least one control unit, said control unit being configured to receive signals from at least one external device;
wherein the control unit is configured to control the opening and closing of the automatic intensive care unit doors based on the received signals.

2. A door management system according to claim 1, further comprising a control terminal for inputting information into the system.

3. A door management system according to claim 1, wherein the system comprises a plurality of control units, each control unit being adapted to control one intensive care unit door.

4. A door management system according to claim 1, wherein the system comprises a central control unit adapted to control all doors.

5. A door management system according to claim 1, wherein at least one external unit is a sensor, a switch or a reader.

6. A door management system according to claim 1, wherein at least one external unit is a fire detection system.

7. A door management system according to claim 1, wherein at least one received signal is a signal from a medical device that alerts medical personnel that a patient requires care.

8. A door management system according to claim 1, wherein the control unit is further adapted to receive at least one internal signal.

9. A door management system for according to claim 8, wherein at least one internal signal is a signal from a senor, a switch or a reader.

10. A door management system according to claim 1, wherein the intensive care unit door has a positive latch function.

11. A method for operating the doors in an intensive care unit door, comprising at least two automatic intensive care unit doors and at least one control unit, comprising the following steps:
a. receiving in said at least one control unit at least one signal from a first external device; and
b. controlling by said at least one control unit the opening and closing of the automatic intensive care unit doors based on the received signals.

12. A method according to claim 11, further comprising the step of receiving information from a control terminal.

13. A method according to claim 11, wherein a plurality of control units, control one intensive care unit door each.

14. A method according to claim 11, wherein a central control unit controls all doors in the intensive care unit.

15. A method according to claim 11, wherein at least one external unit is a sensor, a switch or a reader.

16. A method according to claim 11, wherein at least one received signal is a signal from a fire detection system.

17. A method according to claim 11, wherein at least one received signal is a signal from a medical device that alerts medical personnel that a patient requires care.

18. A method according to claim 11, further comprising the step of receiving at least one internal signal.

19. A method according to claim 11, wherein at least one internal signal is a signal from a sensor, a switch or a reader.

20. A door management system according to claim 11, wherein the intensive care unit door has a positive latch function.
